(19) United States
(12) Patent Application Publication
(10) Pub. No.: US 2018/0329256 A1
(43) Pub. Date: Nov. 15, 2018

(54) POLARIZING PLATE AND LIQUID CRYSTAL DISPLAY DEVICE

(71) Applicant: FUJIFILM Corporation, Tokyo (JP)

(72) Inventors: Shuhei OKUDA, Kanagawa (JP); Yasuyuki SASADA, Kanagawa (JP)

(73) Assignee: FUJIFILM Corporation, Tokyo (JP)

(21) Appl. No.: 16/026,532

(22) Filed: Jul. 3, 2018

Related U.S. Application Data
(63) Continuation of application No. PCT/JP2016/087114, filed on Dec. 13, 2016.

(30) Foreign Application Priority Data
Jan. 5, 2016 (JP) 2016-000547
Feb. 5, 2016 (JP) 2016-020821
Mar. 15, 2016 (JP) 2016-051493
Dec. 2, 2016 (JP) 2016-235400

(51) Int. Cl. G02F 1/1335; G02F 1/1343; B32B 7/12; B32B 27/08; B32B 27/30

(52) U.S. Cl. CPC G02F 1/133528; G02F 1/134363; B32B 7/12; B32B 27/08; B32B 2457/202; G02F 2202/28; B32B 2307/42; B32B 2307/412; B32B 2551/00; B32B 27/306

(57) ABSTRACT

According to the present invention, provided are a polarizing plate including: a polarizing layer; and a transparent layer, in which the transparent layer and the polarizing layer are adhered to each other through an adhesive layer, a film thickness of the adhesive layer is in a range of 1 to 1000 nm, a film thickness of the transparent layer is in a range of 0.1 to 10 μm, a sign of an orientation birefringence and a sign of a photoelastic coefficient of the transparent layer are opposite to each other, and an absolute value of the photoelastic coefficient of the transparent layer is 2×10⁻¹² Pa⁻¹ or greater; and a liquid crystal display device including the polarizing plate.

### CROSS REFERENCE TO RELATED APPLICATION

This is a continuation of International Application No. PCT/JP2016/087114 filed on Dec. 13, 2016, and claims priorities from Japanese Patent Application (JP2016-547) filed on Jan. 5, 2016, Japanese Patent Application (JP2016-20821) filed on Feb. 5, 2016, Japanese Patent Application (JP2016-51493) filed on Mar. 15, 2016, and Japanese Patent Application (JP2016-235400) filed on Dec. 2, 2016, the entire disclosures of which are incorporated therein by reference.

### BACKGROUND OF THE INVENTION

### 1. Field of the Invention

The present invention relates to a polarizing plate and a liquid crystal display device.

### 2. Description of the Related Art

A polarizing plate is an indispensable member constituting a liquid crystal display device. A typical polarizing plate has a configuration in which an optical film is allowed to adhere to one or both surfaces of a polarizing layer formed by adsorbing and aligning a dichroic dye such as an iodine complex on a polyvinyl alcohol (PVA)-based resin.

In recent years, since a decrease in thickness and an increase in size of a liquid crystal display device have been progressing rapidly, a problem of occurrence of light unevenness on a display surface of a liquid crystal display device which is accompanied by environmental change has been apparent.

A decrease in thickness and an increase in size have been progressing even in a case of a polarizing plate serving as an indispensable member of a liquid crystal display device so display failure of a liquid crystal panel is likely to be caused by deformation of a polarizing plate. Specifically, light unevenness is considered to occur because a liquid crystal panel adhered to a polarizing plate is warped, and apart from this, a backlight member or the like is deformed so that the liquid crystal panel and the backlight member are brought into contact with each other in a case where the polarizing plate stretches and contracts.

In order to solve this problem, a system (JP2009-122663A) of using an optical film formed of an acrylic resin having a small photoelastic coefficient has been suggested.

Further, a phase difference film which contains an acrylic resin and a styrene-based resin and has a large film thickness and a large retardation and a polarizing plate (JP2008-146003A) and a phase difference film (JP2008-185659A) which contains a styrene-based resin and has a large film thickness and a large retardation have been suggested.

In addition, a polarizing plate (JP2009-294502A) obtained by laminating a synthetic resin film and a polarizing layer on each other using an adhesive that contains a curable monomer as a main component has been suggested.

### SUMMARY OF THE INVENTION

As the result of examination conducted by the present inventors, it was understood that, since the acrylic film disclosed in JP2009-122663A and the acrylic styrene-based film disclosed in JP2008-146003A have insufficient adhesiveness to a polarizing layer and peeling or cracking occurs in an end surface of a polarizing plate in a case where punching processing is performed on the polarizing plate, scraps are likely to be generated from the end surface of the punched polarizing plate and production suitability is degraded.

It was understood that the styrene-based film disclosed in JP2008-185659A has a large film thickness so that light unevenness easily occurs.

Typically, the film thickness of an adhesive layer which contains, as a main component, the curable monomer disclosed in JP2009-294502A is increased for reasons of production. It was understood that, since deformation of an optical film at the time of performing processing on a polarizing plate tends to remain on the polarizing plate bonded using this adhesive layer and fine deformation having occurred during storage of the optical film remains even after the polarizing plate is processed, display performance related to light unevenness (in other words, luminance unevenness) at the time of black display in a case of observation from the front of the device is degraded.

An object of the present invention is to provide a polarizing plate which has excellent production suitability, shows less deformation failure, and is capable of suppressing light unevenness of a liquid crystal display device which is accompanied by environmental change in a case of being mounted on the liquid crystal display device; and a liquid crystal display device which includes the polarizing plate.

As the result of intensive examination conducted, by the present inventors, on a polarizing plate which includes at least a polarizing layer and one transparent layer, it was found that the above-described problems can be solved by using a transparent layer which has a certain photoelastic coefficient or greater and has a specific film thickness and in which a sign of an orientation birefringence and a sign of a photoelastic coefficient are opposite to each other, and adhering the transparent layer and the polarizing layer through an adhesive layer having a specific film thickness, thereby completing the present invention.

The present inventors found that the adhesiveness between the adhesive layer and the transparent layer can be improved so that the production suitability is improved by using a material having a large absolute value of the photoelastic coefficient as the transparent layer. The reason for this is assumed that an interaction between the adhesive layer and the transparent layer is increased due to a large dipole moment of the material (for example, a polymer resin) having a large photoelastic coefficient.

Further, it is assumed that the deformation failure is improved since fine deformation of the transparent layer can be followed by the smoothness of the polarizing layer or a protective film disposed on the opposite side of the polarizing layer so that the transparent layer can be made flat, by setting the film thickness of the adhesive layer bonding the transparent layer to the polarizing layer to 1000 nm or less.

In a case where the production suitability and the deformation failure are improved in the above-described manner, the photoelastic coefficient of the transparent layer is increased, and retardation occurs due to the influence of internal stress derived from a difference in dimensional change between the transparent layer and the polarizing layer which is accompanied by environmental change. However, it is assumed that the orientation birefringence and the stress birefringence can cancel each other out by setting the sign of the birefringence (orientation birefringence) of the transparent layer and the sign of the photoelastic coefficient (stress birefringence) to be opposite to each other and providing the orientation birefringence within the range not affecting display characteristics, and thus a change in retardation of the transparent layer of the polarizing plate can be reduced. It is considered that the light unevenness of the liquid crystal display device, which is accompanied by the environmental change in a case of being mounted on the liquid crystal display device, can be suppressed as the result of reducing the change in retardation of the transparent layer of the polarizing plate.

Further, since the change in retardation due to the environmental change or the influence of stress can be suppressed or warpage of the panel can be suppressed by reducing the film thickness of the transparent layer by 10 μm or less, the light unevenness of the liquid crystal display device, which is accompanied by the environmental change, is considered to be suppressed.

Accordingly, the present invention as specific means for solving the above-described problems is as follows.

<1> A polarizing plate comprising at least; a polarizing layer; and one transparent layer, in which the transparent layer and the polarizing layer are adhered to each other through an adhesive layer, a film thickness of the adhesive layer is in a range of 1 to 1000 nm, a film thickness of the transparent layer is in a range of 0.1 to 10 μm, a sign of an orientation birefringence and a sign of a photoelastic coefficient of the transparent layer are opposite to each other, and an absolute value of the photoelastic coefficient of the transparent layer is 2×10⁻¹² Pa⁻¹ or greater.

<2> The polarizing plate according to <1>, in which the sign of the orientation birefringence of the transparent layer is negative and the sign of the photoelastic coefficient of the transparent layer is positive.

<3> The polarizing plate according to <1> or <2>, in which an equilibrium moisture absorptivity of the transparent layer is 3% by mass or less.

<4> The polarizing plate according to any one of <1> to <3>, in which a modulus of elasticity of the transparent layer is in a range of 1.0 to 3.5 GPa.

<5> The polarizing plate according to any one of <1> to <4>, in which the transparent layer contains a vinyl aromatic resin.

<6> The polarizing plate according to any one of <1> to <5>, in which the transparent layer contains a styrene-based resin.

<7> The polarizing plate according to any one of <1> to <6>, in which an in-plane retardation of the transparent layer at a wavelength of 590 nm is in a range of 0 to 20 nm, and a retardation of the transparent layer in a thickness direction at a wavelength of 590 nm is in a range of −25 to 25 nm.

<8> The polarizing plate according to any one of <1> to <7>, in which the adhesive layer contains a water-soluble material.

<9> The polarizing plate according to any one of <1> to <8>, in which the polarizing layer contains a polyvinyl alcohol-based resin.

<10> A liquid crystal display device comprising: a liquid crystal cell; and the polarizing plate according to any one of <1> to <9>.

<11> The liquid crystal display device according to <10>, in which the transparent layer is disposed between the polarizing layer and the liquid crystal cell.

<12> The liquid crystal display device according to <10> or <11>, further comprising: a backlight, in which the polarizing plate is disposed closer to the backlight than the liquid crystal cell or closer to a viewing side than the liquid crystal cell.

<13> The liquid crystal display device according to any one of <10> to <12>, in which the liquid crystal cell is of an IPS system.

According to the present invention, it is possible to provide a polarizing plate which has excellent production suitability, shows less deformation failure, and is capable of suppressing light unevenness of a liquid crystal display device which is accompanied by environmental change in a case of being mounted on the liquid crystal display device; and a liquid crystal display device which includes the polarizing plate.

### DESCRIPTION OF THE PREFERRED EMBODIMENTS

The contents of the present invention will be described in detail. The description of the constituent elements below will be made based on representative embodiments of the present invention, but the present invention is not limited thereto. Further, in the present specification, “to” indicates a range including the numerical values described before and after “to” as the lower limits and the upper limits.

In addition, “(meth)acrylate” indicates at least one of acrylate or methacrylate, “(meth)acryl” indicates at least one of acryl or methacryl, and “(meth)acryloyl” indicates at least one of acryloyl or methacryloyl.

A polarizing plate of the present invention includes at least: a polarizing layer; and one transparent layer, in which the transparent layer and the polarizing layer are adhered to each other through an adhesive layer, a film thickness of the adhesive layer is in a range of 1 to 1000 nm, a film thickness of the transparent layer is in a range of 0.1 to 10 μm, a sign of an orientation birefringence and a sign of a photoelastic coefficient of the transparent layer are opposite to each other, and an absolute value of the photoelastic coefficient of the transparent layer is 2×10⁻¹² Pa⁻¹ or greater.

(Transparent Layer)

In the transparent layer, the total light transmittance of visible light (wavelength of 380 to 780 nm) is preferably 80% or greater, more preferably 85% or greater, and still more preferably 90% or greater.

<Photoelastic Coefficient>

In the transparent layer used for the polarizing plate of the present invention, the absolute value of the photoelastic coefficient is 2×10⁻¹² Pa⁻¹ or greater. By setting the absolute value of the photoelastic coefficient of the transparent layer to 2×10⁻¹² Pa⁻¹ or greater, the adhesiveness between the transparent layer and the polarizing layer can be ensured. Further, it can be predicted that optical deviation caused by the internal stress is reduced by appropriately controlling the stress birefringence derived from photoelasticity and the orientation birefringence of the transparent layer described below, and thus light unevenness of a liquid crystal display device which is accompanied by the environmental change can be suppressed in a case where the polarizing plate is mounted on the liquid crystal display device. The absolute value of the photoelastic coefficient of the transparent layer is preferably in a range of 2×10⁻¹² Pa⁻¹ to 100×10⁻¹² Pa⁻¹, more preferably in a range of 4×10⁻¹² Pa⁻¹ to 15×10⁻¹² Pa⁻¹, and still more preferably in a range of 5×10⁻¹² Pa⁻¹ to 12×10⁻¹² Pa⁻¹. In a case where the absolute value of the photoelastic coefficient of the transparent layer is 100×10⁻¹² Pa⁻¹ or less, a change in retardation caused by the stress birefringence is cancelled out by the orientation birefringence without damaging the display characteristics. Therefore, the retardation stability of the polarizing plate can be provided. The photoelastic coefficient of the transparent layer can be controlled by appropriately selecting the materials of the transparent layer and combining two or more materials as necessary. Further, the absolute value of the photoelastic coefficient of the transparent layer may be in the above-described range in at least one optional direction in the plane.

In the present specification, the photoelastic coefficient of the transparent layer can be measured using a film whose film thickness is increased such that self-supporting properties are maintained as necessary. The photoelastic coefficient of a film can be obtained by cutting out a portion of the film to have a size of 5 cm×1 cm such that the measurement direction is set as the longitudinal direction of the film, adjusting the humidity under a temperature condition of 25° C. at a relative humidity of 60% for 2 hours, measuring the in-plane retardation (Re) of the film at a wavelength of 633 nm while a stress (0 to 500 gf) is applied to a sample using a spectroscopic ellipsometer (M-220, manufactured by JASCO Corporation) in the same environment, and performing calculation based on the stress and the inclination of Re.

At this time, in a case where an angle between the direction in which the stress has been changed and the direction of a slow axis of Re is 45° or less, the photoelastic coefficient is set as a positive photoelastic coefficient. Further, in a case where the angle therebetween is larger than 45°, the photoelastic coefficient is set as a negative photoelastic coefficient.

Further, 1 gf indicates 0.00980665N.

<Orientation Birefringence>

In the transparent layer used for the polarizing plate of the present invention, the sign of the orientation birefringence is opposite to the sign of the photoelastic coefficient. Accordingly, a change in retardation accompanied by environmental change is suppressed by cancelling out the orientation birefringence and the stress birefringence occurring in the polarizing plate as described above. The sign of the orientation birefringence of the transparent layer can be controlled by appropriately selecting the materials of the transparent layer and combining two or more materials as necessary.

The orientation birefringence of the transparent layer can be appropriately adjusted such that the orientation birefringence and the stress birefringence derived from photoelasticity can cancel each other out according to the relationship between the photoelastic coefficient and the orientation birefringence.

In addition, the orientation birefringence (retardation described below) may be provided by cancelling the above-described stress birefringence out within the range not damaging the display characteristics, and an orientation treatment of performing heating or stretching or contracting may be carried out before or after the transparent layer and the polarizing layer are laminated.

In the present specification, the sign of the orientation birefringence of the transparent layer can be acquired in a slow axis direction at the time of free end uniaxial stretching at a glass transition temperature described below using a film whose film thickness is increased such that the self-supporting properties can be maintained as necessary, and the birefringence becomes positive in a case where the angle of the slow axis between the stretching direction and the slow axis direction is 45° or less and the birefringence becomes negative in a case where the angle thereof is larger than 45°.

In the present invention, the absolute value of the orientation birefringence is calculated as nx−ny according to a method of measuring the retardation described below. Here, nx represents a refractive index of a film in a slow axis direction and ny represents a refractive index of a film in a fast axis direction.

It is preferable that the sign of the orientation birefringence of the transparent layer is negative and the sign of the photoelastic coefficient of the transparent layer is positive. By setting the sign of the orientation birefringence as negative and the sign of the photoelastic coefficient as positive, the orientation birefringence and the stress birefringence cancel each other out, and a change in retardation due to the environmental change is suppressed. Therefore, light unevenness of the liquid crystal display device can be improved.

<Thickness>

The film thickness of the transparent layer used for the polarizing plate of the present invention is in a range of 0.1 to 10 μm, preferably in a range of 0.5 to 7.0 μm, more preferably in a range of 1.0 to 5.0 μm, and still more preferably in a range of 1.5 to 4.0 μm. The processing suitability and the durability of the polarizing plate can be ensured by setting the film thickness to 0.1 μm or greater and a preferable retardation range can be obtained by setting the film thickness to 10 μm or less. Further, it is preferable that the film thickness is in the above-described range because the effect of reducing the light unevenness of the liquid crystal display device which is accompanied by the environmental change in a case where the polarizing plate is mounted on the liquid crystal display device and the effect of reducing the warpage of the liquid crystal panel which is accompanied by the change of the temperature and the humidity can be expected.

<Retardation>

In the present invention, Re and Rth each represent an in-plane retardation at a wavelength of 590 nm and a retardation in a thickness direction at a wavelength of 590 nm.

In the present invention, Re and Rth represent a value measured at a wavelength of 590 nm using AxoScan OPMF-1 (manufactured by OPTO SCIENCE, INC.). The slow axis direction (°) is calculated by inputting the average refractive index ((nx+ny+nz)/3) and the film thickness (d) in AxoScan.

Re=(nx−ny)×d

Rth=((nx+ny)/2−nz)×d

nx represents a refractive index of a film in a slow axis direction, ny represents a refractive index of a film in a fast axis direction, and nz represents a refractive index of a film in a thickness direction.

The retardation of the transparent layer used for the polarizing plate of the present invention is not particularly limited, but Re is preferably in a range of 0 to 20 nm, more preferably in a range of 0 to 10 nm, and still more preferably in a range of 0 to 5 nm in a case where the transparent layer is used for a liquid crystal display device having an IPS mode. Further, Rth of the transparent layer used for the polarizing plate of the present invention is preferably in a range of −25 to 25 nm, more preferably in a range of −20 to 5 nm, and still more preferably in a range of −10 to 0 nm. In a case where Re and Rth of the transparent layer used for the polarizing plate of the present invention are respectively in the above-described range, light leakage from an oblique direction is further improved and the display quality can be further improved.

<Humidity Dependence of Retardation>

A humidity dependence (ΔRe) of Re of the transparent layer used for the polarizing plate of the present invention is not particularly limited, but is preferably in a range of −20 to 20 nm, more preferably in a range of −10 to 10 nm, and still more preferably in a range of −5 to 5 nm.

The absolute value of the humidity dependence (ΔRth) of Rth of the transparent layer used for the polarizing plate of the present invention is preferably 20 nm or less (in a range of −20 to 20 nm), more preferably in a range of −15 to 15 nm, still more preferably in a range of −10 to 10 nm, and most preferably in a range of −5 to 5 nm.

In the present specification, ΔRe and ΔRth are respectively calculated from a retardation value Re (H %) in an in-plane direction and a retardation value Rth (H %) in a thickness direction under the condition of a relative humidity of H (unit: %) using the following equation.

ΔRe=Re(30%)−Re(80%)

ΔRth=Rth(30%)−Rth(80%)

In the equation. Re (H %) and Rth (H %) are values obtained by adjusting the humidity of the transparent layer under a temperature condition of 25° C. at a relative humidity of (H %) for 24 hours, measuring each retardation value at a relative humidity of H % in conformity with the above-described method of measuring the retardation, and performing calculation. Further, in a case where it is only described as Re without specifying the relative humidity, Re and Rth are values measured at a relative humidity of 60%. In addition, Re and Rth are values at a wavelength of 590 nm unless otherwise noted.

<Modulus of Elasticity>

The modulus of elasticity of the transparent layer used for the polarizing plate of the present invention is not particularly limited, but is preferably in a range of 1.0 to 3.5 GPa, more preferably in a range of 1.5 to 3.3 GPa, and still more preferably in a range of 2.0 to 3.0 GPa. In the present specification, the modulus of elasticity (tensile modulus of elasticity) of the transparent layer can be measured using a film whose film thickness is increased such that the self-supporting properties can be maintained as necessary. The modulus of elasticity of the film can be obtained by cutting out a portion of the film such that the measurement direction becomes the longitudinal direction of the film and a portion to be measured has a size of 10 cm×1 cm, adjusting the humidity under a temperature condition of 25° C. at a relative humidity of 60% for 24 hours, measuring the stress at an elongation of 0.1 and an elongation of 0.5% at a tensile rate of 10%/min using a universal tensile testing machine “STM T50BP” (manufactured by Toyo Baldwin Co., Ltd.), and calculating the modulus of elasticity from the inclination thereof.

<Humidity Expansion Coefficient>

The humidity expansion coefficient of the transparent layer used for the polarizing plate of the present invention is not particularly limited, but is preferably 55 ppm/% RH or less, more preferably in a range of 0 to 40 ppm/% RH, and still more preferably in a range of 0 to 30 ppm/% RH. Since the stress birefringence is considered to be reduced in a case where the humidity expansion coefficient of the transparent layer and the humidity expansion coefficient of the polarizing layer are close to each other, the above-described preferable range can be appropriately corrected according to the characteristics of the polarizing layer.

The humidity expansion coefficient is obtained by cutting out a portion of the film to have a size of 12 cm×5 cm such that the measurement direction becomes the longitudinal direction of the film or the width direction of the film, forming pin holes at intervals of 10 cm using a punch, adjusting the humidity under a temperature condition of 25° C. at a relative humidity of 10% at 25° C. for 24 hours, and measuring the intervals of pin holes using a length measuring device provided with a pair of pins (the measured value is set as L₀). Next, measurement is performed in the same manner as described above by adjusting the humidity under a temperature condition of 25° C. at a relative humidity of 80% for 24 hours (the measured value is set as L₁). The humidity expansion coefficient is calculated using these measured values based on the following equation.

Humidity expansion coefficient [ppm/% RH]={(L₁−L₀)/L₀}/70×10⁶

The value of 70 indicates a difference (%) in the measured humidity.

<Glass Transition Temperature (Tg)>

The glass transition temperature (Tg) of the transparent layer used for the polarizing plate of the present invention or the resin used for the transparent layer is not particularly limited. The Tg can be acquired as a temperature of an intersection between a base line and a tangent on an inflection point from a thermogram obtained by adjusting the humidity under a temperature condition of 25° C. at a relative humidity of 10% for 24 hours, sealing a sample in a measurement pan, and raising the temperature at a rate of 20° ° C./min using a differential scanning calorimeter “DSC6200” (manufactured by Seiko Instruments Inc.).

<Equilibrium Moisture Absorptivity>

The equilibrium moisture absorptivity of the transparent layer used for the polarizing plate of the present invention is not particularly limited, but is preferably 3% by mass or less and more preferably in a range of 0% to 1% by mass. In a case where the equilibrium moisture absorptivity is 3% by mass or less, the dimensional change or change in optical characteristics accompanied by the change in humidity environment can be suppressed so that light unevenness can be suppressed.

The equilibrium moisture absorptivity can be acquired by adjusting the humidity of the film under a temperature condition of 25° C. at a relative humidity of 80% for 24 hours, performing measurement using a moisture measuring device “CA-03” and a sample drying device “VA-05” (both manufactured by Mitsubishi Chemical Corporation) according to a Karl Fischer method, and performing calculation by dividing the moisture content (g) by the mass (g) of the sample.

<Other Characteristics>

It is preferable that other characteristic values of the transparent layer used for the polarizing plate of the present invention are not particularly limited, and the performance equivalent to that of a known typical polarizing plate protective film can be appropriately implemented, and accordingly, the performance required for a so-called inner film disposed between a polarizing layer and a liquid crystal panel is appropriately implemented. Specific examples of the characteristic values include the haze related to display characteristics, the spectral characteristics, the moisture-heat resistance of the retardation, the dimensional change rate accompanied by moisture-heat thermo related to mechanical characteristics or polarizing plate processing suitability, the moisture permeability, and the contact angle.

<Layer Configuration>

The transparent layer used for the polarizing plate of the present invention may be formed of a single layer, may have a laminated structure of two or more layers, or may further include a functional layer. However, it is preferable that the transparent layer used for the polarizing plate of the present invention satisfies the above-described characteristics except for the functional layer.

<Material of Transparent Layer>

The material constituting the transparent layer used for the polarizing plate of the present invention is not particularly limited as long as the orientation birefringence and the photoelastic coefficient are respectively in the preferable range, and a polymer resin or a curable composition containing a reactive monomer can be suitably used.

Polymer Resin

Examples of the polymer resin constituting the transparent layer used for the polarizing plate of the present invention include a vinyl aromatic resin, a cellulose-based resin (a cellulose acylate resin, a cellulose ether resin, or the like), a cyclic polyolefin-based resin, a polyester-based resin, a polycarbonate-based resin, a vinyl-based resin other than a vinyl aromatic resin, and a polyarylate-based resin. Among these, from the viewpoint of the relationship between the orientation birefringence and the photoelastic coefficient, a vinyl aromatic resin is preferable. Here, the vinyl aromatic resin is a vinyl-based resin containing at least an aromatic ring, and examples thereof include a styrene-based resin, a divinylbenzene-based resin, a 1,1-diphenylstyrene-based resin, a vinylnaphthalene-based resin, a vinyl anthracene-based resin, a N,N-diethyl-p-aminoethylstyrene-based resin, and a vinylpyridine-based resin. Further, as a copolymer component, a vinyl pyridine unit, a vinyl pyrrolidone unit, or a maleic anhydride unit may be contained as appropriate. Among examples of the vinyl aromatic resin, from the viewpoint of controlling the photoelastic coefficient and the hygroscopicity, a styrene-based resin is more preferable.

Examples of the styrene-based resin include a resin containing 50% by mass or greater of a styrene-based monomer, and the styrene-based resin may be used alone or in combination of two or more kinds thereof. Here, the styrene-based monomer indicates a monomer having a styrene skeleton in the structure thereof, that is, styrene or a styrene derivative. In the present invention, as a polymer resin, a styrene-based resin described below can be most preferably used. For the purpose of controlling the photoelastic coefficient to be in a preferable range and the hygroscopicity to be in a preferable range, the styrene-based resin contains preferably 50% by mass or greater of a monomer unit derived from a styrene-based monomer, more preferably 70% by mass or greater of the monomer unit, still more preferably 85% by mass or greater of the monomer unit, and most preferably 100% by mass of the monomer unit, in other words, the styrene-based resin is a resin formed of only a styrene-based monomer.

Specific examples of the styrene-based resin include a resin formed of only a styrene-based monomer such as a homopolymer of styrene or a styrene derivative, a copolymer of styrene and a styrene derivative, and a copolymer of two or more kinds of styrene derivatives. Here, the styrene derivative indicates a compound formed by another group being bonded to styrene, and examples thereof include alkylstyrene such as α-methylstyrene, o-methylstyrene, m-methylstyrene, p-methylstyrene, 1,3-dimethylstyrene, 2,4-dimethylstyrene, o-ethylstyrene, p-ethylstyrene, or tert-butylstyrene; and substituted styrene formed by introducing a hydroxyl group, an alkoxy group, a carboxyl group, or a halogen to a benzene nucleus of styrene such as hydroxystyrene, tert-butoxystyrene, vinylbenzoic acid, o-chlorostyrene, or p-chlorostyrene. Among these, from the viewpoints of availability and material price, a homopolymer of styrene (that is, polystyrene) is preferable.

Further, examples of the styrene-based resin include those obtained by copolymerizing other monomer components to styrene-based monomer components. Examples of the copolymerizable monomer include alkyl methacrylate such as methyl methacrylate, cyclohexyl methacrylate, methyl phenyl methacrylate, or isopropyl methacrylate; an unsaturated carboxylic acid alkyl ester monomer of alkyl acrylate or the like such as methyl acrylate, ethyl acrylate, butyl acrylate, 2-ethyl hexyl acrylate, or cyclohexyl acrylate, an unsaturated carboxylic acid monomer such as methacrylic acid, acrylic acid, itaconic acid, maleic acid, fumaric acid, or cinnamic acid; an unsaturated dicarboxylic anhydride monomer which is an anhydride of maleic acid, itaconic acid, ethyl maleic acid, methyl itaconic acid, chloromaleic acid; an unsaturated nitrile monomer such as acrylonitrile or methacrylonitrile; a conjugated diene such as 1,3-butadiene, 2-methyl-1,3-butadiene (isoprene), 2,3-dimethyl-1,3-butadiene, 1,3-pentadiene, or 1,3-hexadiene; vinyl pyridine, and vinyl pyrrolidone, and two or more of these can be co-polymerized.

The polystyrene-based resin is not particularly limited, and examples thereof include a homopolymer of a styrene-based monomer such as general-purpose polystyrene (GPPS) which is a homopolymer of styrene; a copolymer formed of two or more styrene-based monomers as monomer components; a styrene-diene-based copolymer; a copolymer such as a styrene-polymerizable unsaturated carboxylic acid ester-based copolymer; high impact polystyrene (HIPS) such as a mixture of polystyrene and synthetic rubber (for example, polybutadiene or polyisoprene) or polystyrene formed by graft-polymerizing styrene to synthetic rubber; polystyrene (graft type high impact polystyrene, referred to as “graft HIPS”) formed by dispersing a rubber-like elastic body in a continuous phase of a polymer (for example, a copolymer of a styrene-based monomer and a (meth)acrylic acid ester-based monomer) that contains a styrene-based monomer and graft-polymerizing the copolymer to the rubber-like elastic body; and a styrene-based elastomer.

The polystyrene-based resin is not particularly limited and may be hydrogenated. In other words, the polystyrene-based resin may be a hydrogenated polystyrene-based resin (hydrogenated polystyrene-based resin). The hydrogenated polystyrene-based resin is not particularly limited, but a hydrogenated styrene-butadiene-styrene block copolymer (SEBS) which is a resin formed by adding hydrogen to SBS or SIS or a hydrogenated styrene-diene-based copolymer such as hydrogenated styrene-isoprene-styrene block copolymer (SEPS) is preferable. The hydrogenated polystyrene-based resin may be used alone or in combination of two or more kinds thereof.

In addition, the polystyrene-based resin is not particularly limited, but a polar group may be introduced thereinto. In other words, the polystyrene-based resin may be a polystyrene-based resin (modified polystyrene-based resin) into which a polar group has been introduced. Further, examples of the modified polystyrene-based resin include a hydrogenated polystyrene-based resin into which a polar group has been introduced.

The modified polystyrene-based resin is a polystyrene-based resin into which a polar group has been introduced using a polystyrene-based resin as a main chain skeleton. The polar group is not particularly limited, and examples thereof include an acid anhydride group, a carboxylic acid group, a carboxylic acid ester group, a carboxylic acid chloride group, a carboxylic acid amide group, a carboxylate group, a sulfonic acid group, a sulfonic acid ester group, a sulfonic acid chloride group, a sulfonic acid amide group, a sulfonate group, an isocyanate group, an epoxy group, an amino group, an imide group, an oxazoline group, and a hydroxyl group. Among these, an acid anhydride group, a carboxylic acid group, a carboxylic acid ester group, or an epoxy group is preferable; and a maleic anhydride group, or an epoxy group is more preferable. These polar groups may be used alone or in combination of two or more kinds thereof. The modified polystyrene-based resin contains a polar group, which has a high affinity for a polyester-based resin or can be reacted with a polyester-based resin, and is compatible with a polystyrene-based resin, and thus the adhesiveness of the modified polystyrene-based resin to a layer containing a polyester-based resin as a main component or a layer containing a polystyrene-based resin as a main component at room temperature becomes excellent. The polar group may be used alone or in combination of two or more kinds thereof.

The modified polystyrene-based resin is not particularly limited, but a modified product of a hydrogenated styrene-butadiene-styrene block copolymer (SEBS) or a modified product of a hydrogenated styrene-propylene-styrene block copolymer (SEPS) is preferable. In other words, the modified polystyrene-based resin is not particularly limited, but acid anhydride-modified SEBS, acid anhydride-modified SEPS, epoxy-modified SEBS, or epoxy-modified SEPS is preferable; and maleic anhydride-modified SEBS, maleic anhydride-modified SEPS, epoxy-modified SEBS, or epoxy-modified SEPS is more preferable. The modified polystyrene-based resin may be used alone or in combination of two or more kinds thereof.

As the styrene-based resin which can be suitably used in the present invention, from the viewpoint of high heat resistance, a styrene-acrylonitrile copolymer, a styrene-methacrylic acid copolymer, or a styrene-maleic anhydride copolymer can be used.

Further, since the styrene-acrylonitrile copolymer, the styrene-methacrylic acid copolymer, and the styrene-maleic anhydride copolymer are highly compatible with an acrylic resin, a film which has excellent transparency, causes phase separation during utilization, and does not degrade the transparency can be obtained.

In a case of the styrene-acrylonitrile copolymer, the copolymer proportion of acrylonitrile in the copolymer is preferably in a range of 1% to 40% by mass. The copolymer proportion thereof is more preferably in a range of 1% to 30% by mass and still more preferably in a range of 1% to 25% by mass. From the viewpoint of excellent transparency, it is preferable that the copolymer proportion of acrylonitrile in the copolymer is in a range of 1% to 40% by mass.

In a case of the styrene-methacrylic acid copolymer, the copolymer proportion of methacrylic acid in the copolymer is preferably in a range of 0.1% to 50% by mass. The copolymer proportion thereof is more preferably in a range of 0.1% to 40% by mass and still more preferably in a range of 0.1% to 30% by mass. From the viewpoint of excellent heat resistance, it is preferable that the copolymer proportion of methacrylic acid in the copolymer is 0.1% by mass or greater. Further, from the viewpoint of excellent transparency, it is preferable that the copolymer proportion thereof is 50% by mass or less.

In a case of the styrene-maleic anhydride copolymer, the copolymer proportion of maleic anhydride in the copolymer is preferably in a range of 0.1% to 50% by mass. The copolymer proportion thereof is more preferably in a range of 0.1% to 40% by mass and more preferably in a range of 0.1% by mass to 30% by mass. It is preferable that the content of the maleic anhydride in the copolymer is 0.1% by mass or greater from the viewpoint of excellent heat resistance and preferable that the content thereof is 50% by mass or less from the viewpoint of excellent transparency.

The styrene-based resin can be used in combination of a plurality of kinds thereof with different compositions, different molecular weights, or the like.

The styrene-based resin can be obtained by a known anion, bulk, suspension, emulsification, or solution polymerization method. Further, in the styrene-based resin, an unsaturated double bond of a benzene ring in a styrene-based monomer or a conjugated diene may be hydrogenated. The hydrogenation rate can be measured using a nuclear magnetic resonance (NMR) device.

As the styrene-based resin, commercially available products may be used and examples thereof include “CLEAREN 530L”, “CLEARREN 730L” (both manufactured by Denka Company Limited), “TUFPRENE 126S”, “ASAPRENE T411” (both manufactured by Asahi Kasei Corporation), “KRATON D1102A”, “KRATON D1116A” (both manufactured by Kraton Corporation), “STYROLUX S”, “STYROLUX T” (both manufactured by Styrolution Group GmbH), “ASAFLEX 840”, “ASAFLEX 860” (both manufactured by Asahi Chemical Co., Ltd.) (all SBS); “679”, “HF77”, “SGP-10” (all manufactured by PS Japan Corporation), “DICSTYRENE XC-515”, “DICSTYRENE XC-535” (both manufactured by DIC Corporation) (all GPPS); “475D”, “H0103”, “HT478” (all manufactured by PS Japan Corporation), and “DICSTYRENE GH-8300-5” (manufactured by DIC Corporation) (all HIPS). Examples of commercially available products of the hydrogenated polystyrene-based resin include “TUFTEC H Series” (manufactured by Asahi Chemical Co., Ltd.), “KRATON G Series” (manufactured by Shell Japan Ltd.) (all SEBS), “DYNARON” (manufactured by JSR CORPORATION) (hydrogenated styrene-butadiene random copolymer), and “SEPTON” (manufactured by KURARAY CO., LTD.) (SEPS). Further, examples of commercially available products of the modified polystyrene-based resin include “TUFTEC M Series” (manufactured by Asahi Chemical Co., Ltd.), “EPOFRIEND” (manufactured by DAICEL CORPORATION), “polar group-modified DYNARON” (manufactured by JSR CORPORATION), and “RESEDA” (manufactured by TOAGOSEI CO., LTD.).

Examples of the cellulose acylate resin include cellulose acetate, cellulose acetate propionate, cellulose propionate, cellulose acetate butyrate, cellulose acetate propionate butyrate, and cellulose acetate benzoate. Among these, cellulose acetate or cellulose acetate propionate is preferable. The total acyl substitution degree of a cellulose acylate resin is not particularly limited. For example, a cellulose acylate resin having a total acyl substitution degree of 1.50 to 3.00 can be used, and a cellulose acylate resin having a total acyl substitution degree of 2.50 to 3.00 is preferable. In a case where cellulose acetate is used as a cellulose acylate resin, the acetyl substitution degree is preferably in a range of 2.00 to 3.00, more preferably in a range of 2.50 to 3.00, and particularly preferably in a range of 2.70 to 2.95. In a case where cellulose acetate propionate is used as a cellulose acylate resin, it is preferable that the acetyl substitution degree is in a range of 0.30 to 2.80 and the propionyl substitution degree is in a range of 0.20 to 2.70, more preferable that the acetyl substitution degree is in a range of 1.00 to 2.60 and the propionyl substitution degree is in a range of 0.40 to 2.20, and particularly preferable that the acetyl substitution degree is in a range of 1.30 to 2.40 and the propionyl substitution degree is in a range of 0.60 to 1.50.

Examples of the polycarbonate resin include polycarbonate, polycarbonate having a structural unit in which bisphenol A is fluorene-modified, and polycarbonate having a structural unit in which bisphenol A is 1,3-cyclohexylidene-modified.

Examples of the vinyl-based resin other than the vinyl aromatic resin include polyethylene, polypropylene, polyvinylidene chloride, and polyvinyl alcohol.

The weight-average molecular weight (Mw) of the polymer resin constituting the transparent layer used for the polarizing plate of the present invention is not particularly limited, but is preferably in a range of 5000 to 100000, more preferably in a range of 8000 to 70000, and still more preferably in a range of 10000 to 50000.

Further, the weight-average molecular weight of a resin is obtained by measuring the weight-average molecular weight (Mw) in terms of standard polystyrene and molecular weight distribution (Mw/Mn) under the following conditions. In addition, Mn indicates the number average molecular weight in terms of standard polystyrene.

GPC: gel permeation chromatograph device (HLC-8220GPC, manufactured by Tosoh Corporation, column: guard column HXL-H, TSK gel G7000HXL, two sheets of TSK gel GMHXL, and TSK gel G2000HXL (manufactured by Tosoh Corporation) are sequentially linked, eluent: tetrahydrofuran, flow rate: 1 mL/min, sample concentration: 0.7% to 0.8% by mass, sample injection amount: 70 μL, measurement temperature: 40° C. detector: differential refractive index (RI) meter (40° C.), standard material: TSK Standard polystyrene (manufactured by Tosoh Corporation))

The polymer resin constituting the transparent layer used for the polarizing plate of the present invention may be formed of one or two or more kinds thereof. In a case where the transparent layer is formed of multiple layers, the polymer resins of respective layers may be different from one another.

The content of the polymer resin in the transparent layer used for the polarizing plate of the present invention is preferably in a range of 80% to 100% by mass and more preferably in a range of 90% to 99% by mass with respect to the total mass of the transparent layer.

Additives

Known additives can be appropriately mixed into the transparent layer used for the polarizing plate of the present invention. Examples of known additives include a low-molecular-weight plasticizer, an oligomer-based plasticizer, a retardation adjusting agent, a matting agent, an ultraviolet absorbing agent, a deterioration inhibitor, a peeling accelerator, an infrared absorbing agent, an antioxidant, a filler, a compatibilizer, and a leveling agent. The type and the addition amount of each material are not particularly limited. In addition, in a case where the transparent layer is formed of multiple layers, the types and the addition amounts of the additives in each layer may be respectively different from one another.

Matting Agent

It is preferable that fine particles are added to the surface of the transparent layer in order to provide slipperiness and prevent blocking. As the fine particles, silica (silicon dioxide, SiO₂) having a surface covered with a hydrophobic group and being in the form of secondary particles is preferably used. Further, as the fine particles, fine particles such as titanium dioxide, aluminum oxide, zirconium oxide, calcium carbonate, talc, clay, calcined kaolin, calcined calcium silicate, hydrated calcium silicate, aluminum silicate, magnesium silicate, or calcium phosphate may be used together with or in place of silica. Examples of commercially available products of fine particles include R972 and NX90S (trade names, both manufactured by Nippon Aerosil Co., Ltd.).

The fine particles function as a so-called matting agent. Accordingly, even in a case where minute unevenness is formed on a surface of a film due to the addition of fine particles and films overlap each other, the films do not adhere to each other due to this unevenness, and thus the slipperiness of the films is ensured. The minute unevenness formed of protrusions that are formed by fine particles projecting from the film surface exerts high effects of improving the slipperiness and the blocking properties in a case where 10⁴ pieces or more protrusions respectively having a height of 30 nm or greater are present per 1 mm².

From the viewpoint of improving the blocking properties and slipperiness, it is preferable that fine particles serving as a matting agent are applied to a surface layer. Examples of the method of applying fine particles to the surface layer include means for applying fine particles through overlay casting or coating.

Leveling Agent

A known leveling agent (surfactant) can be appropriately mixed into the transparent layer used for the polarizing plate of the present invention. Examples of the leveling agent include known compounds of the related art. Among these, a fluorine-containing surfactant is particularly preferable. Specifically, the compounds described in paragraphs [0028] to [0056] in the specification of JP2001-330725A are exemplified.

<Method of Producing Transparent Layer>

The transparent layer used for the polarizing plate of the present invention can be prepared according to a known solution film formation method, a melt extrusion method, or a method of forming a coating layer on a base film (release film) using a known method. The method of producing the transparent layer can be combined with stretching as appropriate, and a melt extrusion method or a coating method can be particularly preferably used.

According to the solution film formation method, a solution obtained by dissolving the material of the transparent layer in an organic solvent or water is prepared and then uniformly cast on a support after a concentration step or a filtration step is performed as appropriate. Next, the damp-dried film is peeled off from the support, both ends of the web are appropriately held using a clip or the like, and the solvent is dried in a drying zone. Further, the stretching can be separately performed during or after the film is dried.

According to the melt extrusion method, the material of the transparent layer is melt by heat, the filtration step or the like is performed as appropriate, and the melted material is uniformly cast on a support. Next, the cooled and hardened film can be peeled off from the support and then stretched as appropriate. In a case where the main material of the transparent layer of the present invention is a thermoplastic polymer resin, a thermoplastic polymer resin is also selected as the main material of the base film, and film formation can be carried out using a polymer resin in a melted state according to a co-extrusion method. At this time, the adhesiveness between the transparent layer and the base film can be controlled by adjusting the type of the polymer in the transparent layer and the base film or the additives to be mixed into each layer or adjusting the stretching temperature, the stretching speed, or the stretching ratio of the co-extruded film.

Examples of the co-extrusion method include a co-extrusion T-die method, a co-extrusion inflation method, and a co-extrusion lamination method. Among these, a co-extrusion T-die method is preferable. The co-extrusion T-die method is classified into a feed block system and a multi-manifold system. Among these, from the viewpoint of reducing a variation in thickness, a multi-manifold system is particularly preferable.

In a case where the co-extrusion T-die method is employed, the melting temperature of a resin in an extruder having a T die is a temperature equal to or higher than the glass transition temperature (Tg) of each resin by preferably 80° C. and more preferably 100° C. Further, the melting temperature thereof is a temperature equal to or lower than the glass transition temperature (Tg) of each resin by preferably 180° C. and more preferably 150° C. The fluidity of the resin can be sufficiently increased by setting the melting temperature of the resin in an extruder to higher than or equal to the lower limit of the above-described range. Further, deterioration of the resin can be prevented by setting the melting temperature thereof to lower than or equal to the upper limit.

A sheet-like molten resin extruded from an opening of a die is usually brought into contact with a cooling drum. A method of bringing the molten resin into close contact with a cooling drum is not particularly limited, and examples thereof include an air knife system, a vacuum box system, and an electrostatic adhesion system.

The number of cooling drums is not particularly limited and is typically 2 or more. Further, as a method of arranging the cooling drums, a method of arranging cooling drums in a straight line shape, a Z shape, or an L shape is exemplified and not particularly limited. Further, a method of passing a molten resin extruded from an opening of a die through a cooling drum is not particularly limited.

The state in which the extruded sheet-like resin is in close contact with a cooling drum is changed due to the temperature of the cooling drum. In a case where the temperature of the cooling drum is increased, the state of close contact becomes better, but there is a possibility that the sheet-like resin is not peeled off from the cooling drum and wound around the drum at the time of an extreme increase in temperature. Therefore, in a case where the glass transition temperature of the resin on a side of the layer in contact with the drum in the resin extruded from a die is set as Tg, the temperature of the cooling drum is preferably (Tg+30°) C or lower and more preferably in a range of (Tg−5°) C to (Tg−45°) C. In this manner, defects such as slide or scratches can be prevented.

Here, it is preferable that the content of the residual solvent in the pre-stretched film is set to be small. As means for this. (1) means for reducing the amount of the residual solvent of the resin serving as a raw material; and (2) means for pre-drying the resin before the pre-stretched film is formed are exemplified. The pre-drying is performed using a hot air dryer by forming the resin in the pellet form. The drying temperature is preferably 100° C. or higher, and the drying time is preferably 2 hours or longer. By performing the pre-drying, the amount of the residual solvent in the pre-stretched film can be reduced and foaming of the extruded sheet-like resin can be prevented.

According to the coating method, the base film is coated with a solution of the material of the transparent layer to form a coating layer. Since the surface of the base material may be coated with a release agent or the like as appropriate in order to prevent adhesion between the coating layer and the surface of the base material. After the coating layer is laminated on the polarizing layer through an adhesive layer in the post-step, the coating layer can be used by peeling the base film off therefrom. The entire base film can be stretched as appropriate in a state in which a polymer solution or the coating layer is laminated on the base film.

The solvent used in the solution of the material of the transparent layer can be appropriately selected from the viewpoints of capability of dissolving or dispersing the material of the transparent layer, easily obtaining a uniform surface state in the coating step and the drying step, capability of ensuring liquid preservability, and having a moderate saturated vapor pressure.

It is preferable that the transparent layer is subjected to a hydrophilic treatment such as a known glow discharge treatment, corona discharge treatment, or alkali saponification treatment. Further, a corona discharge treatment is most preferably used. The methods or the like disclosed in JP1994-94915A (JP-H06-94915A) or JP1994-118232A (JP-H06-118232A) are preferably applied.

The obtained film can be subjected to a heat treatment step, a superheated steam contact step, or an organic solvent contact step. In addition, the film can be applied as a hard coat film, an antiglare film or an antireflection film by performing a surface treatment thereon.

(Base Film)

The base film used for forming the transparent layer according to the coating method has a film thickness of preferably 5 to 100 μm, more preferably 10 to 75 μm, and still more preferably 15 to 55 μm. It is preferable that the film thickness thereof is 5 μm or greater since sufficient mechanical strength is likely to be ensured and failure such as curling, wrinkling, or buckling is unlikely to occur. Further, it is preferable that the film thickness thereof is 100 μm or less since a surface pressure applied to a laminated film of the transparent layer of the present invention and the base film is easily adjusted to be in an appropriate range in a case where the laminated film is stored in a long roll form and adhesion failure is unlikely to occur.

The surface energy of the base film is not particularly limited, but the adhesive strength between the transparent layer and the base film can be adjusted by adjusting the relationship between the surface energy of the material of the transparent layer or the coating solution and the surface energy of the surface on a side of the base film where the transparent layer is formed. A difference in surface energy is set to be small, the adhesive strength tends to be increased. Further, a difference in surface energy is set to be large, the adhesive strength tends to be decreased. Accordingly, the difference can be appropriately set.

The surface energy of the base film can be calculated using the method of Owens based on the contact angle values of water and methylene iodide. The contact angle can be measured using, for example, DM901 (manufactured by Kyowa Interface Science Co., Ltd., contact angle meter).

The surface energy of the base film on a side where the transparent layer is formed is preferably in a range of 41.0 to 48.0 mN/m and more preferably in a range of 42.0 to 48.0 mN/m. It is preferable that the surface energy is 41.0 mN/m or greater since the uniformity in thickness of the transparent layer can be increased. Further, it is preferable that the surface energy is 48.0 mN/m or less since the peeling force of the transparent layer from the base film is easily controlled to be in an appropriate range.

The surface unevenness of the base film is not particularly limited and can be adjusted for the purpose of preventing adhesion failure in a case where the laminated film of the present invention is stored in a long roll form according to the relationship among the surface energy of the surface of the transparent layer, the hardness, the surface unevenness, the surface energy of the surface of the base film on a side opposite to a side where the transparent layer is formed, and the hardness. In a case where the surface unevenness is increased, the adhesion failure tends to be suppressed. Further, in a case where the surface unevenness is decreased, the surface unevenness of the transparent layer is decreased so that the haze of the transparent layer tends to be decreased. Therefore, the surface unevenness can be appropriately set.

As such a base film, known materials or films can be used as appropriate. Specific examples of the materials include a polyester-based polymer, a polyolefin-based polymer, a cycloolefin-based polymer, a (meth)acrylic polymer, a cellulose-based polymer, and a polyamide-based polymer. Further, a surface treatment can be performed as appropriate for the purpose of adjusting the surface properties of the base film. For example, a corona treatment, a room temperature plasma treatment, or a saponification treatment can be performed in order to decrease the surface energy, and a silicone treatment, a fluorine treatment, or an olefin treatment can be performed in order to increase the surface energy.

(Peeling Force Between Transparent Layer and Base Film)

In a case where the transparent layer used for the polarizing plate of the present invention is formed according to the coating method, the peeling force between the transparent layer and the base film can be controlled by adjusting the material of the transparent layer, the material of the base film, the internal strain of the transparent layer, or the like. The peeling force can be measured by performing a test of peeling the base film in a direction of an angle of 90°, and the peeling force measured at a rate of 300 mm/min is preferably in a range of 0.001 to 5 N/25 mm, more preferably in a range of 0.01 to 3 N/25 mm, and still more preferably in a range of 0.05 to 1 N/25 mm. In a case where the peeling force is 0.001 N/25 mm or greater, it is possible to prevent the base film from peeling off in steps other than the peeling step. In a case where the peeling force is 5 N/25 mm or less, peeling failure (such as zipping or cracking of the transparent layer) in the peeling step can be prevented.

(Polarizing Layer)

As the polarizing layer, for example, a polyvinyl alcohol film or the like after being immersed in an iodine solution and then stretched can be used.

(Adhesive Layer)

The polarizing plate of the present invention is a polarizing plate obtained by adhering the transparent layer and the polarizing layer to each other through an adhesive layer, and the film thickness of the adhesive layer is in a range of 1 to 1000 nm, preferably in a range of 30 to 800 nm, and more preferably in a range of 50 to 500 nm. In a case where the film thickness of the adhesive layer is set to 1 nm or greater, the adhesiveness between the transparent layer and the polarizing layer can be ensured. In a case where the film thickness thereof is set to 1000 nm or less, deformation failure can be reduced.

It is preferable that the adhesive layer in the polarizing plate of the present invention contains a water-soluble material. The transparent layer in the polarizing plate of the present invention has a large photoelastic coefficient as described above. In other words, the transparent layer contains a material having a large dipole moment, and thus the interaction between the transparent layer and the adhesive layer becomes stronger by allowing the adhesive layer to have a polarity using a water-soluble material. Therefore, the adhesiveness between the transparent layer and the adhesive layer is considered to be improved.

Specifically, the surface of the transparent layer, on which the surface treatment has been performed, used for the polarizing plate of the present invention can be allowed to directly adhere to one surface or both surfaces of the polarizing layer using an adhesive formed of an aqueous solution of a polyvinyl alcohol-based resin. As the adhesive, an aqueous solution of polyvinyl alcohol or polyvinyl acetal (such as polyvinyl butyral) or an ultraviolet (UV) curable adhesive can be used, and an aqueous solution of completely saponified polyvinyl alcohol is most preferable.

(Polarizing Plate)

The transparent layer is used as a protective film of the polarizing plate. The polarizing plate of the present invention can be prepared using a known method and is prepared by adhering the polarizing layer and the transparent layer to each other such that an angle between an absorption axis of the polarizing layer and a direction in which an acoustic wave propagating velocity of the transparent layer becomes maximum is parallel or orthogonal to each other.

In the present specification, a case where two straight lines are in parallel with each other includes not only a case where an angle between two straight lines is 00 but also a case where an error is in an optically acceptable level. Specifically, in the case where two straight lines are in parallel with each other, the angle between two straight lines is preferably in a range of 00±10°, more preferably in a range of 0°±5°, and particularly preferably in a range of 0°±10. Similarly, a case where two straight lines are orthogonal (perpendicular) to each other includes not only a case where an angle between two straight lines is 90° but also a case where an error is in an optically acceptable level. Specifically, in the case where two straight lines are orthogonal (perpendicular) to each other, the angle between two straight lines is preferably in a range of 90°±10°, more preferably in a range of 90°±5°, and particularly preferably in a range of 90°±1°.

Another transparent layer may further adhere to the surface opposite to the surface on which the transparent layer adheres to the polarizing layer or a known optical film of the related art may adhere thereto.

The optical characteristics and the materials of the known optical film of the related art are not particularly limited, and a film containing a cellulose ester resin, an acrylic resin, a cyclic olefin resin, and/or polyethylene terephthalate (or containing these as main components) can be preferably used. Further, an optically isotropic film or an optically anisotropic phase difference film may be used.

As the known optical film of the related art which contains a cellulose ester resin, FUJITAC TD40UC (manufactured by Fujifilm Corporation) can be used.

As the known optical film of the related art which contains an acrylic resin, an optical film which contains a (meth)acrylic resin containing a styrene-based resin described in JP4570042B; an optical film which contains a (meth)acrylic resin having a glutarimide ring structure in the main chain described in JP5041532B: an optical film containing (meth)acrylic resin having a lactone ring structure described in JP2009-122664A; and an optical film which contains a (meth)acrylic resin having a glutaric anhydride unit described in JP2009-139754A can be used.

Further, as the known optical film of the related art which contains a cyclic olefin resin, a cyclic olefin-based resin film described after the paragraph 100291 of JP2009-237376A; or a cyclic olefin resin film which contains an additive that decreases Rth described in JP4881827B or JP2008-063536A can be used.

(Peeling of Base Film)

In a case of a melt extrusion method or a coating method which can be preferably used for preparing the transparent layer of the present invention, it is preferable that the method includes a step of peeling and removing the base film of the transparent layer in a stage before a step of forming the adhesive layer on the transparent layer and after a step of adhering the polarizing layer and the transparent layer to each other. The base film is peeled and removed according to the same method as a step of peeling a separator (release film) that is performed on a typical polarizing plate provided with a pressure sensitive adhesive. The base film may be peeled directly after a step of laminating the transparent layer and the polarizing layer of the present invention on each other using an adhesive and drying the laminate or may be peeled separately after a step of temporarily winding the film in a roll shape after the drying step.

(Formation of Pressure Sensitive Adhesive Layer)

It is preferable that a pressure sensitive adhesive layer is formed at least one the transparent layer side in the polarizing plate from which the base film has been peeled off. In order to improve the adhesiveness between the transparent layer and the pressure sensitive adhesive layer, the pressure sensitive adhesive layer can be formed after a surface treatment such as a corona treatment is appropriately performed on the transparent layer and/or the pressure sensitive adhesive layer.

The pressure sensitive adhesive that forms the pressure sensitive adhesive layer is formed of a pressure sensitive adhesive composition which includes a (meth)acrylic resin, a styrene-based resin, or a silicone-based resin as a base polymer and to which a crosslinking agent such as an isocyanate compound, an epoxy compound, or an aziridine compound has been added. Further, the pressure sensitive adhesive layer exhibiting light scattering properties can be obtained by allowing the layer to contain fine particles. The thickness of the pressure sensitive adhesive layer is typically in a range of 1 to 40 μm and preferably in a range of 3 to 25 nm.

Further, an antistatic agent can be appropriately added to the pressure sensitive adhesive layer, and a compound having organic cations or an antistatic agent having inorganic cations can be preferably used. Among these, an antistatic agent having inorganic cations can be more preferably used. A known compound can be used as an antistatic agent. Ionic compounds described in paragraphs [0067] to 100771 of JP2011-504537A can be preferably used as the compound having organic cations and metal salts described in paragraphs [0045] and [0046] of JP2008-517137A can be preferably used as the compound having inorganic cations.

(Liquid Crystal Display Device)

The liquid crystal display device of the present invention includes a liquid crystal cell and the polarizing plate of the present invention.

The liquid crystal display device of the present invention can be suitably used in a case where the transparent layer is disposed inside (in other words, between the polarizing layer and the liquid crystal cell) or outside (in other words, the surface on a side opposite to the surface on a liquid crystal cell side) of the polarizing layer. In the liquid crystal display device of the present invention, it is preferable that the transparent layer is disposed between the polarizing layer and the liquid crystal cell.

It is preferable that the liquid crystal display device of the present invention includes a backlight and the polarizing plate is disposed closer to a backlight side than the liquid crystal cell or closer to a viewing side than the liquid crystal cell. The backlight is not particularly limited, and known backlights can be used. It is preferable that the liquid crystal display device of the present invention is obtained by laminating the backlight, a backlight-side polarizing plate, the liquid crystal cell, and a viewing side polarizing plate in this order.

As for other configurations, any configurations of known liquid crystal display devices can also be employed. The system (mode) of the liquid crystal cell is not particularly limited, and the liquid crystal display device can be configured as any of liquid crystal display devices having various display systems such as a twisted nematic (TN) liquid crystal cell, an in-plane switching (IPS) liquid crystal cell, a ferroelectric liquid crystal (FLC) liquid crystal cell, an anti-ferroelectric liquid crystal (AFLC) liquid crystal cell, an optically compensatory bend (OCB) liquid crystal cell, a supper twisted nematic (STN) liquid crystal cell, a vertically aligned (VA) liquid crystal cell, and a hybrid aligned nematic (HAN) liquid crystal cell. Among these, in the liquid crystal display device of the present invention, an IPS liquid crystal cell is preferable.

### Examples

Hereinafter, the present invention will be described in more detail with reference to examples. The materials, the use amounts, the ratios, the treatment contents, and the treatment procedures shown in the examples described below can be changed as appropriate within the range not departing from the gist of the present invention. Therefore, the scope of the present invention is not limited to the specific examples shown below.

<<1>> Production and Evaluation of Transparent Layer

The following materials were used.

1] Resin

Resin 1:

Commercially available polystyrene (SGP-10, manufactured by PS Japan Corporation. Tg of 100° C.) was heated to 110° C., cooled to room temperature (23° C.), and then used.

Resin 2:

Commercially available ARTON (G7810, manufactured by JSR CORPORATION, Tg of 168° C.) was heated to 110° C., cooled to room temperature, and then used.

Resin 3:

A commercially available acrylic resin (BR-83, manufactured by MITSUBISHI RAYON CO., LTD., Tg of 105° C.) was heated to 110° C., cooled to room temperature, and then used.

Resin 4:

Polyethylene terephthalate was produced using a titanium catalyst according to the same method as in Example 1 described in paragraphs [0098] to [0104] of JP2007-70462A and was formed in a pellet form.

Resin 5:

A commercially available acrylic film (TECHNOLOGY S001G, manufactured by Sumitomo Chemical Co., Ltd.) was cut out, heated to 110° C., cooled to room temperature, and then used.

2] Additive

Matting agent 1: silicon dioxide fine particles, NX90S (manufactured by Nippon Aerosil Co., Ltd., particle size of 20 nm. Mohs hardness of approximately 7)

Leveling agent 1: A surfactant having the following structure was used. In the following structural formula, t-Bu represents a tert-butyl group.

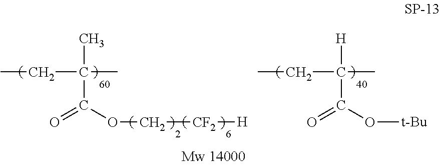

3] Base Film

Base material 1:

A polyethylene terephthalate film (film thickness of 38 μm) was prepared, and a polyethylene terephthalate film which was not subjected to an easy adhesion treatment was used as a base material 1.

Base material 2:

A polyethylene terephthalate film (film thickness of 100 μm) which was not subjected to an easy adhesion treatment was prepared, and a polyethylene terephthalate film which was subjected to a corona treatment as an easy adhesion treatment was used as a base material 2.

Base material 3:

A commercially available polyethylene terephthalate film LUMIRROR® S105 (film thickness of 38 μm, manufactured by TORAY INDUSTRIES, INC.) was used as a base material 3.

Base material 4:

A commercially available polyethylene terephthalate film LUMIRROR® S10 (film thickness of 12 μm, manufactured by TORAY INDUSTRIES, INC.) was used as a base material 4.

Base material 5:

A commercially available polyethylene terephthalate film EMBLET S38 (film thickness of 38 μm, manufactured by Unitika Ltd.) was used as a base material 5.

<Transparent Layer 1>

(Preparation of Resin Solution)

The following material group was stirred in a mixing tank together with a toluene solvent having a moisture absorptivity of 0.2% by mass or less so as to be dissolved, thereby obtaining a resin solution having a concentration of solid contents of 10% by mass.

Resin 1

| | |
|---|---|
| Additive | 0.02% by mass (% by mass with respect |
| (matting agent 1) | to the content of the resin 1) |

In addition, the moisture absorptivity of the solvent was obtained by performing measurement using a moisture measuring device “CA-03” and a sample drying device “VA-05” (both manufactured by Mitsubishi Chemical Corporation) according to a Karl Fischer method, and performing calculation by dividing the moisture content (g) by the mass (g) of the sample.

Next, the obtained solution was filtered using filter paper (#63, manufactured by Toyo Roshi Kasha. Ltd.) having an absolute filtration accuracy of 10 μm and further filtered using a metal sintered filter (FH025, manufactured by Pall Corporation) having an absolute filtration accuracy of 2.5 μm, thereby obtaining a resin solution 1.

(Preparation of Transparent Layer)

The base material 1 was continuously coated with the resin solution 1 using a bar coater such that the thickness of the dried film was set to 3.0 μm and dried at 100° C., and a transparent layer 1 was formed on the base material 1.

<Transparent Layer 2>

A transparent layer 2 was obtained in the same manner as that for the transparent layer 1 except that the resin 1 was changed to the resin 2.

<Transparent Layer 3>

A transparent layer 3 was obtained in the same manner as that for the transparent layer 1 except that the resin 1 was changed to the resin 3 and the toluene solvent was changed to an acetone solvent (moisture absorptivity of 0.4% by mass or less).

<Transparent Layer 4>

A film forming device for co-extrusion forming a film formed of two different kinds of two layers was prepared.

Pellets of the resin 1 were put into a first twin-screw extruder provided with a screw and melted and kneaded at 230° C. in a nitrogen stream, thereby obtaining a melt. Similarly, pellets of the resin 4 were melted and kneaded at 280° C., thereby obtaining a melt. The melts of the resin 1 and the resin 4 were respectively allowed to pass through a gear pump and a filter to be supplied to a multi-manifold die, simultaneously extruded at 260° C., and a laminate of molten resins having a two layer structure with a layer of the resin 1 and a layer of the resin 4 was continuously prepared. The laminate of the molten resins was extruded onto a chilled roll to prepare an un-stretched film. The film thickness of the resin layer 1 in the obtained un-stretched film was 24 μm and the film thickness of the resin layer 4 in the obtained un-stretched film was 304 μm.

The obtained un-stretched film was longitudinally stretched three times at 11° C. and then laterally stretched three times at 120° C., thereby obtaining a laminated film having the resin layer 1 (defined as a transparent layer 4) with a film thickness of 3 μm and the resin layer 4 with a film thickness of 38 μm.

<Transparent Layer 5>

The following material group was stirred in a mixing tank together with an ethyl acetate solvent having a moisture absorptivity of 0.2% by mass or less so as to be dissolved, thereby obtaining a resin solution having a concentration of solid contents of 9% by mass. The filtration of the resin solution and the preparation of the transparent layer were performed in the same manner as that for the transparent layer 1 except that the drying temperature was changed to 115° C., thereby obtaining a transparent layer 5.

Resin 1

| | |
|---|---|
| Additive | 0.02% by mass (% by mass with respect |
| (leveling agent 1) | to the content of the resin 1) |

<Transparent Layer 6>

A transparent layer 6 was obtained in the same manner as that for the transparent layer 5 except that the film thickness of the transparent layer was changed to 5.0 μm from 3.0 μm.

<Transparent Layer 7>

A transparent layer 7 was obtained in the same manner as that for the transparent layer 6 except that the base material 1 was changed to the base material 2.

<Transparent Layer 8>

A transparent layer 8 was obtained in the same manner as that for the transparent layer 5 except that the base material 1 was changed to the base material 3.

<Transparent Layer 9>

A transparent layer 9 was obtained in the same manner as that for the transparent layer 8 except that the film thickness of the transparent layer was changed to 5.0 μm from 3.0 μm.

<Transparent Layer 10>

A transparent layer 10 was obtained in the same manner as that for the transparent layer 5 except that the base material 1 was changed to the base material 4.

<Transparent Layer 11>

A transparent layer 11 was obtained in the same manner as that for the transparent layer 1 except that the resin 1 was changed to the resin 5.

<Transparent Layer 12>

A transparent layer 12 was obtained in the same manner as that for the transparent layer 5 except that the film thickness of the transparent layer was changed to 25 μm from 3.0 μm.

<Transparent Layer 13>

A transparent layer 13 was obtained in the same manner as that for the transparent layer 6 except that the base material 1 was changed to the base material 5.

<Transparent Layer 14>

A transparent layer 14 was obtained in the same manner as that for the transparent layer 5 except that the film thickness of the transparent layer was changed to 12 μm from 3.0 μm.

(Evaluation of Transparent Layer)

The sign of the orientation birefringence, the photoelastic coefficient, the equilibrium moisture absorptivity, the modulus of elasticity, Re, and Rth of each transparent layer prepared in the above-described manner were acquired, and the respective numerical values are listed in Table 1.

TABLE 1

| | | | | | | | Equilibrium | | | |
|---|---|---|---|---|---|---|---|---|---|---|
| | | | | | Sign of | Photoelastic | moisture | Modulus of | | |
| | | | | Thickness | orientation | coefficient | absorptivity | elasticity | Re | Rth |
| | Resin | Additive | Base film | [μm] | birefringence | [×10⁻¹² Pa⁻¹] | [% by mass] | [GPa] | [nm] | [mm] |
| Transparent | Resin 1 | Matting agent 1 | Base material 1 | 3.0 | Negative | 9 | 0.0 | 3.0 | 0.3 | −4 |
| layer 1 | | | | | | | | | | |
| Transparent | Resin 2 | Matting agent 1 | Base material 1 | 3.0 | Positive | 3 | 0.3 | 2.5 | 0.5 | 8 |
| layer 2 | | | | | | | | | | |
| Transparent | Resin 3 | Matting agent 1 | Base material 1 | 3.0 | Negative | −3 | 1.6 | 3.5 | 0.1 | −2 |
| layer 3 | | | | | | | | | | |
| Transparent | Resin 5 | Matting agent 1 | Base material 1 | 3.0 | Negative | −1 | 1.6 | 3.5 | 0.1 | −1 |
| layer 11 | | | | | | | | | | |
| Transparent | Resin 1 | None | (Resin 4) | 3.0 | Negative | 8 | 0.0 | 3.0 | 0.3 | −3 |
| layer 4 | | | | | | | | | | |
| Transparent | Resin 1 | Leveling agent 1 | Base material 1 | 3.0 | Negative | 9 | 0.0 | 3.0 | 0.3 | −3 |
| layer 5 | | | | | | | | | | |
| Transparent | Resin 1 | Leveling agent 1 | Base material 1 | 5.0 | Negative | 9 | 0.0 | 3.0 | 0.4 | −5 |
| layer 6 | | | | | | | | | | |
| Transparent | Resin 1 | Leveling agent 1 | Base material 2 | 5.0 | Negative | 9 | 0.0 | 3.0 | 0.1 | −4 |
| layer 7 | | | | | | | | | | |
| Transparent | Resin 1 | Leveling agent 1 | Base material 3 | 3.0 | Negative | 9 | 0.0 | 3.0 | 0.2 | −3 |
| layer 8 | | | | | | | | | | |
| Transparent | Resin 1 | Leveling agent 1 | Base material 3 | 5.0 | Negative | 9 | 0.0 | 3.0 | 0.4 | −4 |
| layer 9 | | | | | | | | | | |
| Transparent | Resin 1 | Leveling agent 1 | Base material 4 | 3.0 | Negative | 9 | 0.0 | 3.0 | 0.7 | −3 |
| layer 10 | | | | | | | | | | |
| Transparent | Resin 1 | Leveling agent 1 | Base material 1 | 25 | Negative | 9 | 0.0 | 3.0 | 2.3 | −27 |
| layer 12 | | | | | | | | | | |
| Transparent | Resin 1 | Leveling agent 1 | Base material 5 | 5.0 | Negative | 9 | 0.0 | 3.0 | 0.3 | −4 |
| layer 13 | | | | | | | | | | |
| Transparent | Resin 1 | Leveling agent 1 | Base material 1 | 12 | Negative | 9 | 0.0 | 3.0 | 1.0 | −11 |
| layer 14 | | | | | | | | | | |

<<2>> Preparation and Evaluation of Polarizing Plate

(Preparation of Polarizing Plate)

1] Surface Treatment on Film

A corona treatment was performed on the surface of each of the transparent layers 1 to 14 on the opposite side of the base film to prepare transparent layers 1 to 14 on which a surface treatment was performed.

Further, a cellulose acetate film (FUJITAC TD40UC, manufactured by Fujifilm Corporation) was immersed in 1.5 mol/L of a sodium hydroxide aqueous solution (saponification liquid), whose temperature was adjusted to 37° C., for 1 minute, washed with water, immersed in 0.05 mol/L of a sulfuric acid aqueous solution for 30 seconds, and then allowed to pass through a washing bath. Further, draining was repeated three times using an air knife, water was dropped on the resulting film, and the film was allowed to stand in a drying zone at 70° C. for 15 seconds and dried, thereby preparing a cellulose acetate film on which a saponification treatment was performed.

2] Preparation of Polarizing Layer

In the same manner as in Example 1 of JP2001-141926A, a difference in peripheral speed was provided for a space between two pairs of nip rolls so that stretching was carried out in the longitudinal direction, thereby preparing a polarizing layer containing a polyvinyl alcohol resin with a thickness of 12 μm.

3] Adhesion

By using a material obtained by storing the polarizing layer obtained in the above-described manner, the transparent layer on which the surface treatment was performed, and the cellulose acetate film on which the saponification treatment was performed in a roll state for 3 months, the polarizing layer was interposed between the transparent layer and the cellulose acetate film, the layers were laminated such that an absorption axis of the polarizing layer was in parallel with the longitudinal direction of the film according to a roll-to-roll system through an adhesive layer obtained by using the following adhesive listed in Table 2. Here, one film of the polarizing layer was set such that any one corona-treated surface from among the transparent layers 1 to 14 was on the polarizing layer side and the cellulose acetate film was set as the other film.

Adhesive 1: A 3 mass % aqueous solution in polyvinyl alcohol (PVA-117H, manufactured by Kuraray Co., Ltd.) was used as an adhesive.

Adhesive 2: An adhesive was prepared in conformity with the adhesive A described in Example 1 of JP2009-294502A.

Next, polyethylene terephthalate serving as a base film of the transparent layer was continuously peeled off using the same device as the peeling device of a separator provided with a peeling roller after being dried at 70° C., coated with a commercially available acrylate-based pressure sensitive adhesive, thereby preparing a polarizing plate.

(Evaluation of Polarizing Plate)

1) Visual Inspection (Deformation Failure) on Polarizing Plate

The polarizing plate was visually inspected over 300 m using reflected light of a fluorescent lamp, and the surface unevenness deformation of the polarizing plate was evaluated based on the following standards.

A: Deformation failure was not found from even in one site.

B: Deformation failure occurred in one or more sites.

C: Deformation failure occurred in five or more sites.

The standards A and B are in levels indicating that there are no practical problems. The standard A is preferable.

2] Punching Inspection of Polarizing Plate Before being Mounted on Liquid Crystal Display Device

100 sheets of polarizing plates were punched out using a Tomson blade having a size of 40 mm×40 mm, the states of peeling or cracking of end surfaces were observed, and evaluation was performed based on the following standards.

A: Peeling or cracking did not occur in any of 100 sheets of polarizing plates.

B: Peeling or cracking occurred in one or more sheets of polarizing plates.

C: Peeling or cracking occurred in three or more sheets of polarizing plates.

D: Peeling or cracking occurred in five or more sheets of polarizing plates.

The standards A and B are in levels indicating that there are no practical problems, and the standard C is in a level indicating that practical use is possible. The standard A is preferable.

In addition, among the polarizing plates of each example and each comparative example, only polarizing plates in which peeling or cracking of end surfaces did not occur were used for performing evaluation of mounting polarizing plates on a liquid crystal display device described below.

3] Evaluation of Mounting Polarizing Plate on Liquid Crystal Display Device (Mounting Polarizing Plate on IPS Type Liquid Crystal Display Device)

The prepared polarizing plate described above was used as a rear-side (backlight-side) polarizing plate of an IPS mode liquid crystal television (slim type 55 type liquid crystal television, the clearance between the backlight and the liquid crystal cell was 0.5 mm), and the prepared transparent layer and the liquid crystal cell were allowed to adhere to each other through a pressure sensitive adhesive such that the transparent layer was disposed on the liquid crystal cell side. The obtained liquid crystal television was transferred to an environment at 25° C. and at a relative humidity of 60% after being held in an environment at 50° C. and at a relative humidity of 85% for 3 days, continuously lighted up in a black display state, and visually observed after 48 hours. Thereafter, light unevenness (the light unevenness level in the front direction after a durability test) was evaluated.

The light unevenness (in other words, luminance unevenness and color unevenness) was observed at the time of black display in a case where the device was observed from the front side and in an oblique direction, and the evaluation was performed based on the following standards.

AA: Unevenness was unlikely to be visually recognized in an environment of an illuminance of 20 lx.

A: Unevenness was unlikely to be visually recognized in an environment of an illuminance of 100 lx.

B: Light unevenness was visually recognized in an environment of an illuminance of 100 lx.

C: Unevenness was visually recognized in an environment of an illuminance of 100 lx.

D: Clear unevenness was visually recognized in an environment of an illuminance of 100 lx.

The standards AA, A, and B are in levels indicating that there are no practical problems, and the standards AA and A are preferable.

TABLE 2

| | | | | Thickness of | Deformation failure | Production suitability | Light unevenness |
|---|---|---|---|---|---|---|---|
| | | Type of | Type of | adhesive layer | (visual | (punching | (evaluation |
| | Polarizing plate | transparent layer | adhesive | [nm] | inspection) | inspection) | of mounting) |
| Example 1 | Polarizing plate 1 | 1 | 1 | 100 | A | A | AA |
| Comparative | Polarizing plate 2 | 1 | 2 | 2800 | C | A | A |
| Example 1 | | | | | | | |
| Comparative | Polarizing plate 3 | 2 | 1 | 100 | A | C | C |
| Example 2 | | | | | | | |
| Comparative | Polarizing plate 4 | 3 | 1 | 100 | A | C | C |
| Example 3 | | | | | | | |
| Comparative | Polarizing plate 12 | 11 | 1 | 100 | A | D | AA |
| Example 4 | | | | | | | |
| Example 2 | Polarizing plate 5 | 4 | 1 | 100 | A | A | AA |
| Example 3 | Polarizing plate 6 | 5 | 1 | 100 | A | A | AA |
| Example 4 | Polarizing plate 7 | 6 | 1 | 100 | A | A | AA |
| Example 5 | Polarizing plate 8 | 7 | 1 | 100 | A | A | AA |
| Example 6 | Polarizing plate 9 | 8 | 1 | 100 | A | A | AA |
| Example 7 | Polarizing plate 10 | 9 | 1 | 100 | A | A | AA |
| Example 8 | Polarizing plate 11 | 10 | 1 | 100 | A | A | AA |
| Comparative | Polarizing plate 13 | 12 | 1 | 100 | A | A | D |
| Example 5 | | | | | | | |
| Example 9 | Polarizing plate 14 | 13 | 1 | 100 | A | A | AA |
| Comparative | Polarizing plate 15 | 14 | 1 | 100 | A | A | C |
| Example 6 | | | | | | | |

As listed in Table 2, it was understood that the polarizing plates of the examples of the present invention had no deformation failure and had excellent production suitability and thus light unevenness of the liquid crystal display device which was accompanied by the environment change was able to be suppressed in a case of mounting any of these polarizing plates on the liquid crystal display device.

According to the present invention, it is possible to provide a polarizing plate which has excellent production suitability, shows less deformation failure, and is capable of suppressing light unevenness of a liquid crystal display device which is accompanied by environmental change in a case of being mounted on the liquid crystal display device; and a liquid crystal display device which includes the polarizing plate.

The present invention has been described in detail with reference to the specific embodiments, but it will be apparent to those skilled in the art that various changes and modifications can be made without departing from the spirit and the scope of the present invention.

What is claimed is:

1. A polarizing plate comprising at least:
a polarizing layer; and
one transparent layer,
wherein the transparent layer and the polarizing layer are adhered to each other through an adhesive layer,
a film thickness of the adhesive layer is in a range of 1 to 1000 nm,
a film thickness of the transparent layer is in a range of 0.1 to 10 μm,
a sign of an orientation birefringence and a sign of a photoelastic coefficient of the transparent layer are opposite to each other, and
an absolute value of the photoelastic coefficient of the transparent layer is 2×10⁻¹² Pa⁻¹ or greater.

2. The polarizing plate according to claim 1,
wherein the sign of the orientation birefringence of the transparent layer is negative and the sign of the photoelastic coefficient of the transparent layer is positive.

3. The polarizing plate according to claim 1,
wherein an equilibrium moisture absorptivity of the transparent layer is 3% by mass or less.

4. The polarizing plate according to claim 1,
wherein a modulus of elasticity of the transparent layer is in a range of 1.0 to 3.5 GPa.

5. The polarizing plate according to claim 1,
wherein the transparent layer contains a vinyl aromatic resin.

6. The polarizing plate according to claim 1,
wherein the transparent layer contains a styrene-based resin.

7. The polarizing plate according to claim 1,
wherein an in-plane retardation of the transparent layer at a wavelength of 590 nm is in a range of 0 to 20 nm, and
a retardation of the transparent layer in a thickness direction at a wavelength of 590 nm is in a range of −25 to 25 nm.

8. The polarizing plate according to claim 1,
wherein the adhesive layer contains a water-soluble material.

9. The polarizing plate according to claim 1,
wherein the polarizing layer contains a polyvinyl alcohol-based resin.

10. A liquid crystal display device comprising:
a liquid crystal cell; and
the polarizing plate according to claim 1.

11. The liquid crystal display device according to claim 10,
wherein the transparent layer is disposed between the polarizing layer and the liquid crystal cell.

12. The liquid crystal display device according to claim 10, further comprising:
a backlight,
wherein the polarizing plate is disposed closer to the backlight than the liquid crystal cell or closer to a viewing side than the liquid crystal cell.

13. The liquid crystal display device according to claim 10,
wherein the liquid crystal cell is of an IPS system.
